(19) United States
(12) Patent Application Publication
(10) Pub. No.: US 2009/0315969 A1
(43) Pub. Date: Dec. 24, 2009

(54) Method for Creating an Image on a Support

(76) Inventor: Jean-Luc Lesur, Bras (FR)

Correspondence Address: BUCHANAN, INGERSOLL & ROONEY PC, POST OFFICE BOX 1404, ALEXANDRIA, VA, 22313-1404, US

(21) Appl. No.: 12/083,202

(22) PCT Filed: Oct. 3, 2006
(86) PCT No.: PCT/EP2006/066982

§ 371 Date: Apr. 15, 2009

(30) Foreign Application Priority Data
Oct. 7, 2005 (FR) 05/10291

(51) Int. Cl. B41J 2/435; F16M 13/00

(52) U.S. Cl. 347/232; 248/694

(57) ABSTRACT

The invention relates to a method of creating an image, such as a printed and/or customised graphic element, on a support having regions that can be activated by an activator. A support is used that includes at least a plurality of regions that can reveal a colour under the effect of an activator. These regions are offset in relation to one another when observed from the activator. The colour is only activated in a localised manner on the aforementioned regions.

The present invention relates to the creation of an image on a support. The image may more particularly be a colour image, however it is also possible to implement the invention for creating a monochrome image.

The support may be any support. However, the invention more particularly aims at information supports having the dimensions of a chip card, such as a plastic card.

Such cards include images (which may be decorative elements and/or informative elements—the word of “image” being understood in the broad sense of a visual element), such as, for example, a photographic reproduction, on their main faces. Such images may be created using various known methods, more particularly with the aim of customising the support. An application of the creation of image is thus the customisation of chip cards.

Some methods for creating images use the processing of the support with light beams such as laser beams.

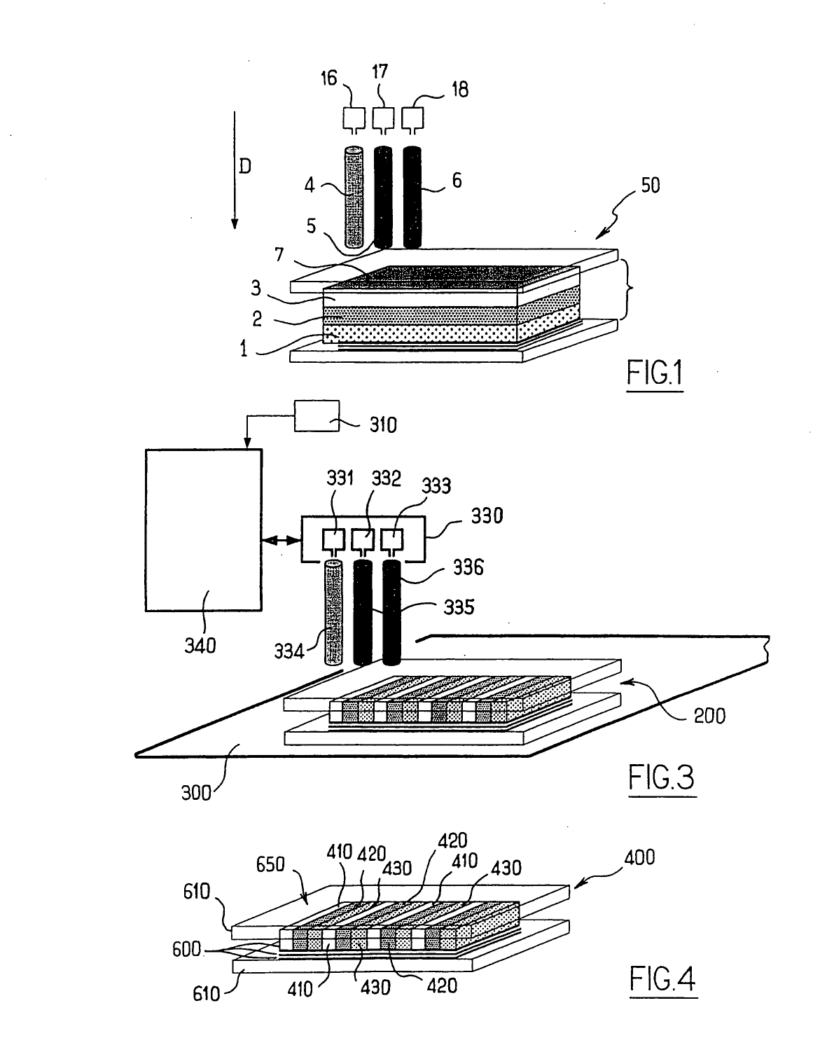

FIG. 1 thus illustrates a known method for creating a colour image on a support 50 using light beams.

In this Figure, the support 50 including three layers 1, 2, 3 is exposed to the beams 4, 5, 6 of three respective lasers 16, 17, 18.

Each of the lasers 16, 17, 18 has a different wavelength.

Each layer 1, 2 or 3 includes a respective and distinct component capable of producing a colour (so-called an elementary colour ) when it is exposed to the beam 4, 5 or 6 of a respective laser 16, 17 or 18.

More precisely, in the case of FIG. 1, the component of each layer is capable of producing a respective elementary colour when the layer wherein it is contained is exposed to one of the three laser beams—and the component does not react to the other two lasers.

For example, a first component located in a first layer 1 is capable of producing a first colour when it is exposed to a light beam 4 the particular feature of which is to be a first wavelength λ1. A second component located in a second layer 2 is capable of producing a second colour when it is exposed to a light beam 5 having a second wavelength λ2. A third component located in a third layer 3 is capable of producing a third colour when it is exposed to a light beam 6 having a third wavelength λ3.

The three above-mentioned colours may for example correspond to elementary colours or colours (for example, red, yellow and blue, respectively). They are referred to as “elementary” colours, since they may be combined to form different colours.

In this text, the term “colour” means a colouration or a discolouration, created by the activation of an activator, particularly a temperature activator, or under the effect of a light beam having a wavelength adapted to make the component react. In the sense of such definition adopted for this text, the discolouration is thus to be also understood as being a “colour”.

The components may be reagents, pigments, colouring agents, heat-sensitive agents, any type of agent capable of changing colour or becoming transparent or yet being sublimed (to let another colour show), this in a selective way, when it is activated, for example, by being exposed to a light beam having a given wavelength for producing a colour.

The light beams mentioned in the present text may be light beams, the wavelength of which is concentrated about a peak having a unique wavelength (a laser beam, for example), or about several peaks (the case of beams having several main wavelengths).

As will be discussed in the following, such beams play the part of activators of the components and are thus a particular illustration of “activators” in the broadest sense—but other types of activators may be considered within the scope of the invention.

The three layers 1, 2, 3 shown in FIG. 1 are vertically superimposed with respect to the plane of the support 50 (such plane corresponding, traditionally, to a so-called “horizontal” plane) and such layers cover the same surface when they are observed along direction D of the beams 4, 5, 6.

To create a colour image, successive scans of the whole surface 7 of the support 50 are carried out with the lasers 16, 17, 18 for selectively exposing spots of the support 50 to the beam 4, 5, 6 of each laser 16, 17, 18.

For example, the operation starts by scanning the whole surface of the support 50 with the light beam 4 having the first wavelength emitted by the first laser 16. This laser 16 selectively etches spots of the support 50 with the light beam having the first wavelength 4 associated with the first component 1, with a view to creating the first elementary colour that the first component can generate at the irradiated spots of the support 50.

The “selective” characteristic of the laser beam etching is obtained through a controlled supply of the laser so as to supply it only when its beam must meet the support at the spots which are to be etched, and/or by using masks which let the laser beam through, only at the level of such spots.

A first set of spots has thus been “colour” (by colouration or discolouration) according to the first elementary colour.

Then, a second scanning is carried out with the light beam 5 having the second wavelength, to selectively etch spots of a second set of spots and locally create thereon the second elementary colour by reaction with the second component, then a third scanning is carried out with the light beam 6 having the third wavelength, for selectively etching spots of a third set of spots and locally create thereon a third elementary colour by reaction with the third component.

The thus colour spots of these three sets of spots make it possible to create a colour image, starting from the elementary colours and their combinations, if any, on the same spots.

Each beam scans the whole surface of the support. There about, the pitch of the scanning of the beam is adapted (case of scanning successive parallel lines on the surface of the support) so that the pitch corresponds to the diameter of the beam.

In the case of a support 50, such as a plastic card, having the dimensions of a chip card, the duration of the passage of a laser 16, 17, 18 on the whole surface 7 of the support 50 is of the order of 10 seconds (for an image of 300 dpi corresponding to a surface, 25×20 mm in dimensions).

As the various scans are carried out sequentially, the total time for creating a colour image is greater than or equal to 30 seconds in the case of a support comprising three components such as the one illustrated in FIG. 1.

It should be mentioned, though, that an alternative to what has just been described, in which the support comprises a layer combining several components, is illustrated in document EP 912 916.

One aim of the present invention is to provide a method and an associated system making it possible to reduce the time required for creating a colour image on a support.

Another aim of the invention is to make it possible to obtain a high quality image (more particularly, as regards clarity).

Another aim of the invention consists in reducing the costs of the creation of a colour image on a support.

For this purpose, a method is provided for creating an image such as a printed and/or customised graphic element on a support including regions that may be activated by an activator, characterised in that
a support is provided, comprising at least a plurality of regions capable of revealing a colour under the effect of an activator, said regions being offset in relation to one another, when observed from the activator,
and in that the colour is only activated in a localised manner on the said regions.

Preferred but non-limitative aspects of the method according to the invention are as follows:
the support provided includes three pluralities of regions, each plurality being capable of revealing a determined colour under the effect of an activator,
the position of each region is pre-recorded and it includes an activation checking step, so as to activate only said regions,
the regions include at least one component,
the regions cover components capable of being sublimed or becoming transparent under the effect of an activator,
the activator is selected among a temperature probe, and a beam of electromagnetic wave beam, a laser,
the regions are arranged in bands on the surface of the support,
the bands form an iterative pattern on the surface of the support.

Besides, according to another aspect, the invention provides a support comprising an external surface of at least a plurality of regions that can be activated and which are capable of revealing a colour under the effect of an activator, said regions being offset in relation to one another, as seen from the outside, perpendicularly to said surface.

Preferred but non-limitative aspects of the support according to the invention are as follows:
said regions of the support are arranged on the surface of the support in a substantially continuous manner,
said regions of the support are arranged in bands,
the regions form an iterative pattern on the surface of the support.

The invention also relates to the use of a support such as defined hereabove for manufacturing a customised card.

Other characteristics and advantages of the invention will become more evident from the reading of the following description, which is only an illustration and not a limitation, and should be read while referring to the appended drawings in which, in addition to FIG. 1, which is an illustration of the method for creating a colour image of the prior art and which has already been discussed hereabove:

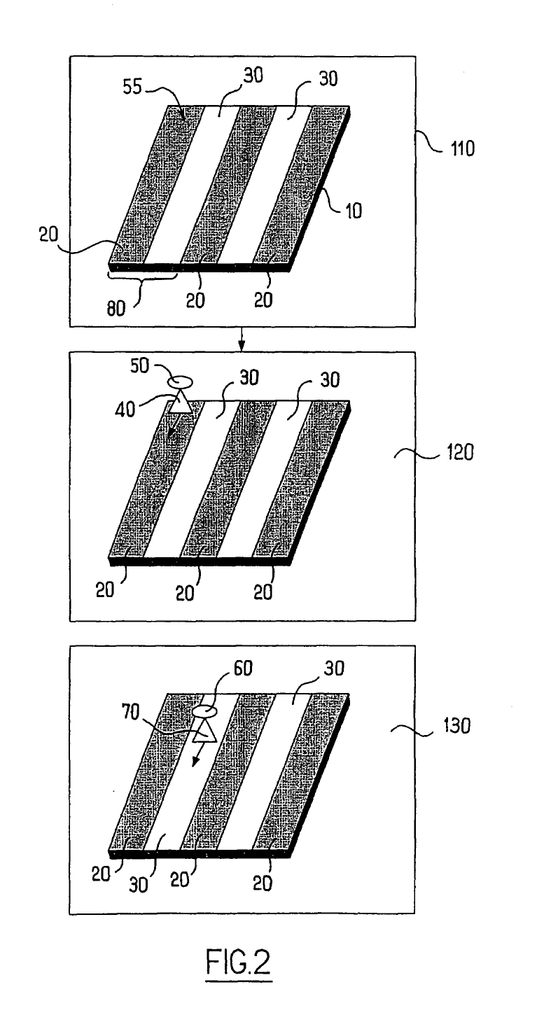

FIG. 2 is an illustration of an embodiment of the method according to the invention,

FIG. 3 is an illustration of a system capable of implementing an embodiment of a method according to the invention,

FIG. 4 is an illustration of an advantageously adapted support for the method according to the invention,

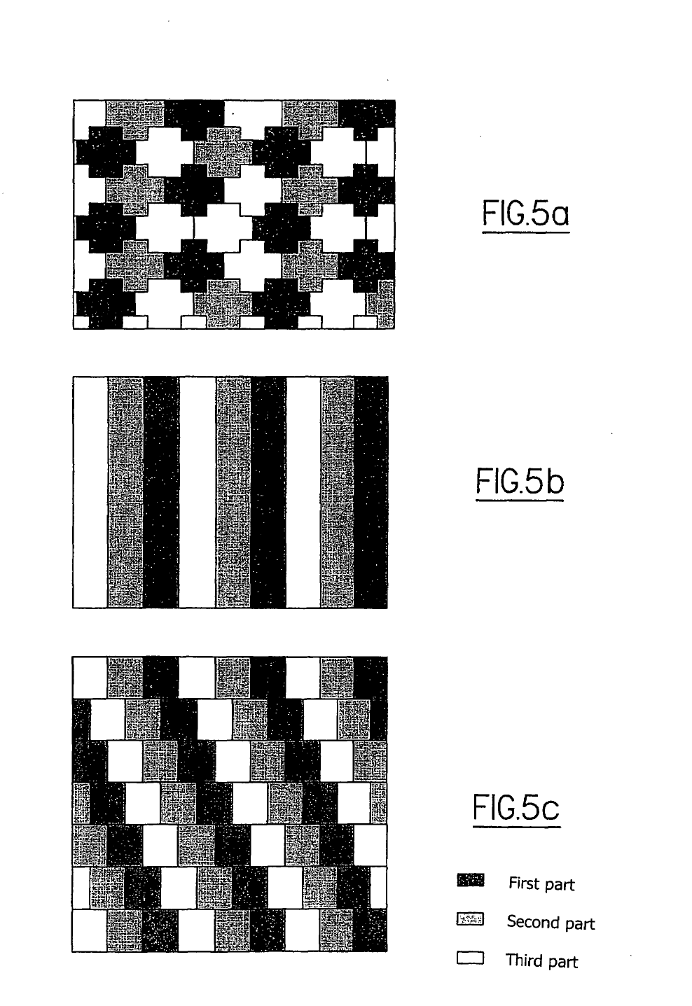

FIGS. 5a to 5c illustrate three possible distributions of parts of a support as regards its surface for an advantageous implementation of the invention,

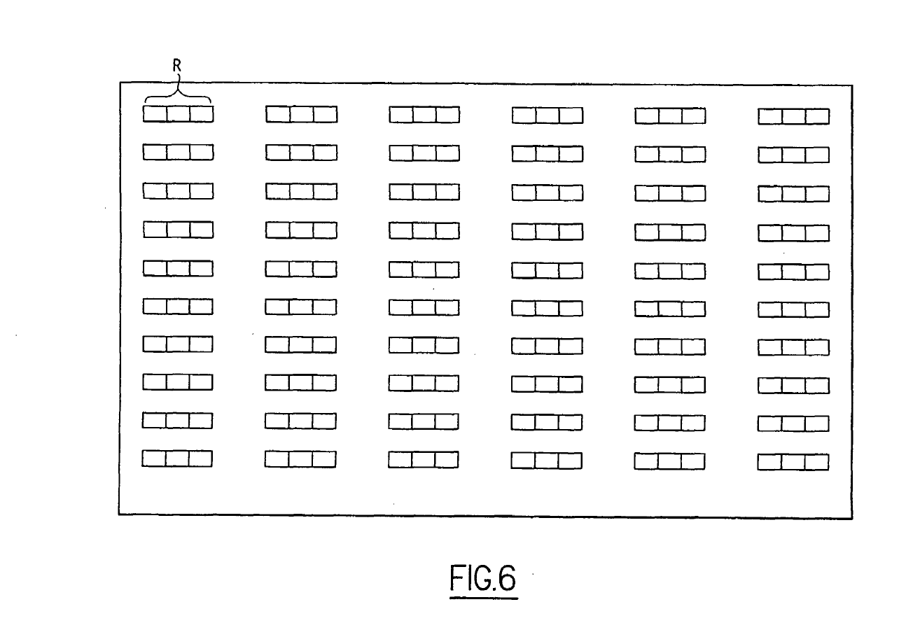

FIG. 6 illustrates another possible distribution of parts of a support as regards its surface for an advantageous implementation of the invention.

The invention more particularly provides a method for creating a colour image on a support, the support including at least two components, each component being capable of producing a respective elementary colour when it is exposed to a respective light beam having respective characteristics, the method comprising the scanning of regions on the surface of the support with the light beams respectively associated with said components, with a view to creating local elementary colours in the material of the support, by a selective exposition of local areas of the support to one or the other of said light beams, the method making it possible to create a colour image starting from said local elementary colours and their combinations, if any, on such local areas, this method being characterised in that:
the method includes, for each light beam, the definition, on the surface of the support, of a pattern region which is individually associated with said light beam, and
the method comprises the checking of the scanning by the light beams so as to scan only the region of the pattern which is associated with each light beam.

Particular aspects of this method are as follows:
said characteristics of the light beams are wavelength characteristics,
said light beams are laser beams,
said local areas are spots making it possible to compose an image,
for each light beam, said pattern regions are arranged on the surface of the support in order to enable an essentially continuous scanning of said pattern regions,
said pattern regions are arranged in bands,
the bands associated with the various light beams form an iterative pattern on the surface of the support,

and the invention also provides a system for creating a colour image on a support, the support including at least two components, each component being capable of producing a respective elementary colour when it is exposed to a respective light beam having respective characteristics, the system making it possible to create a colour image starting from said local elementary colours and their combinations, if any, on the same local areas, the system being characterised in that it includes means capable of:
for each light beam, defining on the surface of the support pattern regions which are individually associated with said light beam,
controlling the scanning of the light beams so as to scan, with each light beam, only said pattern regions which are individually associated with said light beam.

Finally, as will be seen hereinafter, the invention also provides a support such as a plastic card comprising at least two components, each component being capable of producing a respective elementary colour when it is exposed to a respective light beam having respective characteristics, the various components being distributed in various respective layers, characterised in that said layers extend in order to be opposite respective various regions of the surface of the support, thus defining for each component at least one region on the surface of the support.

Such a support may more particularly have the following characteristics:
said regions of the surface of the support are arranged on the surface of the support in a substantially continuous way,
said regions of the surface of the support are arranged in bands,
the bands associated with the various components form an iterative pattern on the surface of the support,
said layers are formed in a support sheet which extends substantially parallel to the surface of the support.

While referring to FIG. 2, an embodiment of the method according to the invention is schematically illustrated. Such method makes it possible to create a colour image on a support such as a card having the dimensions of a chip card, for example made of plastic.

The method may be applied to any type of support comprising at least two components.

As previously mentioned, a “component” may be a photosensitive component such as mentioned in the preamble to this text, capable of producing an elementary colour (such as for example yellow, cyan or magenta) in reaction to an exposition to a light beam having particular characteristics.

It is also possible to use components which can be totally or partly sublimed or removed from the layer in which they are initially located, in order to produce an elementary colour in reaction to an exposition to an activator, such as a light beam or a laser beam having particular characteristics.

<<particular characteristics>> typically means the wavelength of the beam (or a wavelength, in the case where the beam includes several wavelengths) capable of making the component generate an elementary colour in reaction to an exposition to said light beam. This (non limitative) example of the wavelength as a particular characteristic will be developed in the text, hereinunder.

The method according to the invention can be applied to a support of a known type, for example:
a support as illustrated in FIG. 1 and include, along a direction perpendicular to the surface of the support on which it is desired to create an image, a superimposition of layers which can, each, include a different component,
or a support as taught by the document EP 912 916.

The method according to the invention can also be applied to other types of supports known by persons skilled in the art, such as supports including only one layer instead of a superimposition of layers, while such single layer can include a mixture of several components.

As will be seen hereinunder, such method can also be applied to a special type of support, which corresponds to an advantageous aspect of the invention.

In a step 110 of the method, pattern regions 20, 30 to be customised are defined on the surface of the support 50, on which it is desired to create an image. Such regions, which thus form a pattern on the surface of the support, will be called “pattern regions”.

The pattern regions may be defined so as to form a partition covering the whole surface on which it is desired to create an image, or so as to cover only a part of this surface.

In FIG. 2, such regions 20, 30 are sets of extended and alternating bands, extending parallel on the surface of the support. The pattern region 20 is thus composed of the set of the bands bearing reference number 20 in this Figure, and the pattern region 30 is composed of the set of the bands bearing reference number 30.

The surface of the support will be scanned by several light beams, each of which is associated with one or several specific wavelengths.

It is also possible to provide the scanning of the surface of the support with only one beam, including at least two main wavelengths, in the case where a special support is used, as mentioned above, and which will be discussed further down in the text.

The surface of the support will be scanned by at least two different wavelengths. And as will be explained hereinunder, such scanning will be carried out in a particular way.

As regards this scanning operation, it is indicated that pattern regions are not only defined, but each pattern region is further associated with one of the wavelengths of the beam or beams with which the surface of the support will be scanned.

Such “association” of each beam region with one wavelength means that, during the scanning of the surface of the support by the beam or beams, each beam will scan only the pattern region which is associated with the wavelength of the beam (or with a wavelength thereof if the beam has several ones).

Thus, each beam will not systematically scan the whole surface of the support, as this is the case in the state of the art, which is illustrated in FIG. 1. Then, a scanning of the surface may be carried out in a short time. The activation time will be reduced by a factor of at least three with respect to the prior art for a support comprising three components.

Reversely, each pattern region will be scanned only by the beam containing the wavelength associated with said region.

Each pattern region includes at least one component. And in any case, each pattern region comprises a component capable of reacting to the exposition of a beam having the wavelength associated with the region for creating a particularly elementary colour. The elementary colours so associated with the various wavelengths are different from each other.

The distribution of components in the elementary regions will be discussed further down in this text.

During the scanning of each pattern region by the beam which it is associated with, a selective etching of some spots of the pattern region is carried out to create locally an associated elementary colour. The selective etching is carried out by any means known per se (checking of the beam supply while it scans the pattern regions which it is associated with, use of a mask, etc.).

Then, elementary colours distributed in a controlled way on the surface of the support, are carried out in a reduced time.

In the example of FIG. 2, each pattern region is individually associated with one of two light beams 40, 70, each beam being itself associated with particular characteristics which are its own (typically as regards the wavelength—in this text, the example of the wavelength is used as a particular feature but in the absolute, such characteristics may be different (energy or intensity, time of exposure, laser pulse type and any other, for example)). Thus, each pattern region is associated with only one of the beams having different characteristics.

It should be noted that, in addition to the specific provisions discussed about the invention, it is generally possible to provide, in addition, an additional beam for selectively blackening some places of the surface of the support, for example with a view to increasing the contrast.

The pattern regions 20, 30 are arranged on the surface of the support 10, so as to allow an optimised scanning of said pattern region 20, 30. A “optimised scanning” is defined as a scanning, wherein the path followed by the light beam or beams is minimised (total length of the path followed by the beam plus the jumps between the pattern regions).

Providing regions 20, 30, which may be scanned with a continuous scanning, is a way to obtain such an optimisation.

Within the scope of the present invention, “continuous scanning” means a strictly continuous scanning (such as, for example, in the case where the beam moves along only one pattern region covering the surface to be treated—for example, an helicoidal pattern region) or continuous “in pieces” which reduces the jumps between the various areas (such as, for example, in the case where the beam moves along distinct segments or bands). It should be understood that the continuous characteristic of the scanning is independent from the fact of continuously supplying the beam with energy or not—it simply relates to a way of moving the place of impact of the beam (if the latter is supplied and if the beam is not cut) on the surface of the support.

In one embodiment, the pattern regions 20, 30 are arranged in sets of bands. Such bands associated with the various beams 40, 70 may form an iterative pattern 80 on the surface of the support 10.

In other embodiments, such pattern regions may be arranged so as to form networks of areas or spots (discreet and separated or connected together) which are uniformly distributed according to a determined pitch, full disks, hyphens forming an iterative pattern which may be intended to increase security and homogeneity of the customisation.

It should be noted about such embodiments, wherein each pattern region is arranged in a set of discreet areas or spots that, in a particular embodiment, n pattern regions defined (n being an integer greater than or equal to two), the pattern regions being composed while referring to a set of discreet regions such as small rectangles, distributed (preferably regularly) on the surface of the support.

Thus, it is possible, as illustrated in FIG. 6:
to define a set of small rectangles R (rectangles or any other shape—the representation of FIG. 6 is only a particular illustration of such embodiment) on the surface of the support,
Each of these rectangles including n areas—here, three areas—which each form a part of a respective pattern region,
Thus, three pattern regions are made:
   A first pattern region which gathers the “first areas” of each rectangle R (for example, for each rectangle R the leftmost rectangle R in the Figure),
   A second pattern region which gathers the “second areas” of each rectangle R (for example, for each rectangle R the central area of the rectangle in the Figure),
   A third pattern region which gathers the “third regions” of each rectangle R (for example, for each rectangle R the rightmost area of the rectangle in the Figure).

Then the scanning of each pattern region will be carried out with a respective beam, as this will be explained in greater details hereinunder.

It should be noted that this FIG. 6 (and its adaptations, wherein different shapes of rectangles are used as elementary shapes) corresponds to an advantageous embodiment, since it makes it possible to place components only at certain locations on the support, the surfaces located between the rectangles being free of any component.

This allows an economic embodiment of the support since the components are usually expensive.

Such embodiment makes it possible to compose images in a particularly simple way, while keeping the advantages mentioned hereabove.

In this embodiment, the support of image includes at least a plurality of regions which may be activated and which are offset in relation to each other as observed from the outside, perpendicularly to said surface (which means offset in relation to each other when such regions are observed along a direction perpendicular to the surface of the support).

It should be noted that a support of the type illustrated in FIG. 6 may further be used with any known method for creating an image which uses the scanning of a set of spots on the surface of the support for processing the support with one or several light beam or beams (for example, an image may be created on such a support with a method, such as illustrated in FIG. 1 or with a method as taught by document EP 912 916).

However, in an advantageous embodiment, the activation is localised on the regions of the support including the component.

Such localised activation more particularly makes it possible to:
limit the energy loss during the activation connected to the scanning of the surfaces of the support free of any component, and
to reduce the time of exposure and thus reduce the time required for creating an image;

In case such a support is used with a known method, the advantage of saving the components of the support is more particularly preserved.

It should also be noted that this type of configuration may also be used for a simplified embodiment of the invention, wherein a single colour image is constituted. This simplified embodiment will be discussed later.

An exemplary scanning of the surface of the support by beams 40 and 70 will now be discussed in details.

At step 120 of the method, the first light beam 40 coming from a light source 50 is moved so that such first light beam 50 scans only the first pattern region 20 which is associated with it.

During such scanning a selective etching of some areas of the region 20 is carried out with the beam 40.

Such step aims at generating, in some areas of the regions 20, a first locally elementary colour in the material of the support through the selective exposure of local areas of the support and activation of the component or the components of these areas which is/are associated with the wavelength of the first beam 40.

The local areas are, for example, spots. They will make it possible to take part in the constitution of an image.

More precisely, the areas exposed to the first light beam correspond to desired spots of the first pattern region according to the desired customisation for the image to be created.

For this purpose, the exposure of the support to the beam is carried out, spot by spot, and the transversal dimension (typically the diameter) of the beam contacting the support is controlled, so that it corresponds to the desired dimension of the spots, by:
using a light beam having an adapted diameter (for example, by using a focusing lens),
or by using a beam having a diameter greater than the desired diameter for the spot and interposing, between the light source and the support, a filter or a mask hiding the parts of the support which should not be exposed.

The etching is thus oriented towards precise spots of the first pattern regions of the surface of the layer to be printed according to the desired pattern.

At another step 130 of the method, a second light source 60 capable of emitting the second light beam 70 is moved. Such moving of the second source 60 is controlled so that the second light beam 70 only scans the second pattern regions 30 which are individually associated with it.

And during such step, a selective etching will be carried out with the beam 70 to create a second elementary colour at the desired spots with the components contained in the pattern region 30.

Such step, as a matter of fact, aims at generating a second locally elementary colour in some areas of the region 30, in the material of the support, by a selective exposure of local areas of the support and activation of the component or the components of such areas, which is/are associated with the wavelength of the second beam 70.

Thus, each light source 50, 60 does not move on the whole surface of the support to be printed, but on only a part on the surface of the support.

It should be noted that it is even possible to carry out the scanning of the various pattern regions with various beams simultaneously (in the example which has just been cited, these beams carrying out steps 120 and 130 simultaneously), by using, for example, a comb which would carry such beams side by side and by moving the comb above the surface of the support, so that each beam scans only the pattern region which it is associated with.

For example, on a support including three components, by using three beams, the customisation time is reduced by a factor of nine, with respect to a known configuration of the prior art, in which the whole surface of the support would be scanned with each of the three beams and where these three scanning operations would, besides, be sequentially carried out one after the other.

While referring to FIG. 3, an embodiment of a system implementing the method described above is illustrated.

Such system includes a base 300, entering means 310 and control means 320, capable of controlling a plurality of light sources (such sources are three in number, in this particular example).

The base 300 is intended to receive the support 200 on which it is desired to create an image. In one embodiment, such base is fixed. In another embodiment, the base is capable of moving, the moving of the base being controlled by the control means.

The entering means 310 make it possible for a user to enter the user settings such as, for example, the number of components of the support 200 to be processed.

The light sources 331, 332, 333 of the plurality of light sources 330 are of any type known by the persons skilled in the art. In one embodiment, the light sources 331, 332, 333 are lasers emitting laser beams 334, 335, 336, each component being sensitive to a particular wavelength.

The control means 340 are, for example, a computer programmed for implementing the method steps and more particularly, for controlling the scanning of the light beam 334, 335, 336 coming from each source 331, 332, 333 of the light sources 330.

In any case, the steps for defining the pattern regions and the adapted scanning make it possible to have only certain components of the layer or layers, react to create the elementary colours while scanning with each beam only the pattern region which it is associated with.

It is also possible to implement the invention on a particular support, which will now be described.

While referring to FIG. 4, a support 400 according to the invention, particularly adapted to the utilisation with the method and the system for creating a colour image is illustrated.

Such support 400 is, for example, a plastic card such as a payment card, identification card or phone card type, etc.

The support 400 is obtained by rolling together several layers or sheets of material:
the card body 600, which constitutes the set of sheets more particularly including a so-called card “core” sheet, or a sheet (in the case where the body is reduced to the core) which is relatively thick (having a thickness of the order of 1 mm). Such body is, in the case of plastic cards, generally made of PVC (polyvinyl chloride) or PET (polyethylene) or PC (polycarbonate)
two thinner coating sheets 610 (of the order of a few dozens or even a few hundreds of micrometers) stuck onto both faces of the body 600. Such coating sheets 610 are called “overlay” according to the common English terminology. They are generally transparent.
and in some cases, intermediate adhesive layers between the body and the coating sheets. Such adhesive layers are intended, more particularly, to make the body and the coating layers integral.

The card body 600 of the support 400 has one (or several) coating(s), which include(s) the three different components, which may be arranged by various methods, which may be the inkjet, the material jet, the offset printing, the silkscreen printing.

Each component is capable of producing a particular colour when it is exposed to a particular light beam having particular characteristics.

The first, second and third components are respectively distributed in first, second and third parts 410, 420, 430 which are arranged to form a pattern on the surface of the support—here, bands.

It is also possible to provide any number of “parts”, each one being associated with one component—and each component being itself associated with a beam having a given wavelength which it may react with for generating an elementary colour.

Each part 410, 420, 430 extends so as to be located opposite various respective regions of the surface 650 of the support 400, which thus define for each component at least one region on the surface 650 of the support 400.

Besides, such regions will advantageously be used as “pattern regions” within the scope of the method described hereabove.

In the embodiment illustrated in FIG. 4, parts 410, 420, 430 extend in the thickness of the support 400 and belong to the same sheet substantially parallel to the surface of the support 400.

In one embodiment, the parts of the surface 650 of the support 400 are arranged on the surface 650 of the support 400 in a substantially continuous way. For example, in one embodiment, the regions of the surface of the support are arranged in bands, and form an iterative pattern on the surface of the support.

It is also possible to distribute such various parts in a generally homogeneous way opposite a surface of the support, in one plurality of discreet areas separated from each other. This is illustrated in FIGS. 5a to 5c, which are three examplary distributions of three parts opposite the surface of the support.

The reader will understand that the support according to the invention is not limited to the embodiment illustrated in FIG. 4.

It is also true for the method and the system according to the invention, which may be adapted to any type of support comprising at least one component.

It should also be noted that in the case of the implementation of the invention on the support, the surface of which is partitioned into various pattern regions, the fact of avoiding to vertically superimpose (which means in a direction perpendicular to the surface on which the image is to be created) the components and the colours also makes it possible to avoid superimposing wastes and other particles which are associated thereto and which will tend to reduce the clarity of the image obtained. The invention then makes it possible to create images of an improved quality (more particularly in terms of clarity).

Further, in the case where the invention is implemented with a light beam comprising several main wavelengths, the number of light sources is reduced which corresponds to some savings.

The invention also makes it possible to save on components which may be activated in the support.

Although the present invention has been mainly described in the case of components capable of revealing a colour through the exposure to a light beam, it is possible to implement the invention with components activated in another way than exposure to a light beam. Then, (and in a non-limitative way), it is possible to implement the invention with components that are activated, for example, by a temperature probe or an electromagnetic wave beam.

It should also be noted that the invention may be implemented according to a simplified embodiment, wherein only one pattern region is defined on the surface of the support.

In this case again, the pattern region may be a continuous region or the combination of discreet areas or spots, separated from each other. The single pattern region may thus be constituted with the combination of discreet areas such as rectangles R in FIG. 6—simply in this case, the support will include only one component at the level of rectangles.

In this simplified embodiment, the only one pattern region may have only one component.

Such component may react in a different way to different wavelengths to create different elementary colours. In this case, the pattern region may be scanned with several beams, several areas of the pattern region being scanned by one (or some) beam or beams only with a view to creating different elementary colours in the different areas of the single pattern region.

This simplified embodiment makes it possible to use a support having only one component.

And in a particular variation of this simplified embodiment, the scanning of the pattern region is carried out with one and only one beam. In this case, a single colour image is created by generating the unique elementary colour that the unique component produces in response to the exposure of the unique beam at the places where such exposure is carried out.

1. A method for creating an image on a support comprising regions that may be activated by an activator, wherein
a support is provided which includes at least a plurality of regions that may reveal a colour under the effect of an activator, said regions being offset in relation to one another, when observed from the activator,
and wherein the colour is only activated in a localised manner on said regions.

2. A method according to claim 1, wherein the support includes three pluralities of regions, each plurality being capable of revealing a determined colour, under the effect of an activator.

3. A method according to claim 2, wherein the position of each region is pre-recorded and further including a step of activation checking, so as to activate only said regions.

4. A method according to claim 1, wherein the regions include at least one component capable of reacting in a different way to various wavelengths to create different colours.

5. A method according to claim 1, wherein the regions cover components capable of being sublimed or becoming transparent under the effect of an activator.

6. A method according to claim 1, wherein the activator is selected among a temperature probe, a beam of electromagnetic waves, and a laser.

7. A method according to claim 1, wherein the regions are arranged in bands on the surface of the support.

8. A method according to claim 7, wherein the bands form an iterative pattern on the surface of the support.

9. A support including an external surface and at least a plurality of regions that may be activated and capable of revealing a colour under the effect of an activator, said regions being offset in relation to one another, as seen from the outside, perpendicularly to said surface.

10. A support according to claim 9, wherein said regions of the support are arranged at the surface (650) of the support in a substantially continuous way.

11. A support according to claim 9, wherein said regions of the support are arranged in bands.

12. A support according to claim 9, wherein the regions form an iterative pattern on the surface of the support.

13. The utilisation of a support according to claim 9, for manufacturing a customised map.

14. A support according to claim 10, wherein said regions of the support are arranged in bands.

15. A support according to claim 10, wherein the regions form an iterative pattern on the surface of the support.

16. A support according to claim 11, wherein the regions form an iterative pattern on the surface of the support.

17. The utilisation of a support according to claim 10, for manufacturing a customised map.

18. The utilisation of a support according to claim 11, for manufacturing a customised map.

19. The utilisation of a support according to claim 12, for manufacturing a customised map.
